(19) United States
(12) Patent Application Publication
(10) Pub. No.: US 2025/0261245 A1
(43) Pub. Date: Aug. 14, 2025

(54) VALIDITY OF RANDOM ACCESS CHANNEL OCCASIONS IN SUBBAND FULL DUPLEX SLOTS

(71) Applicant: QUALCOMM Incorporated, San Diego, CA (US)

(72) Inventors: Abdelrahman Mohamed Ahmed Mohamed IBRAHIM, San Diego, CA (US); Muhammad Sayed Khairy ABDELGHAFFAR, San Jose, CA (US); Qian ZHANG, Basking Ridge, NJ (US); Ahmed Attia ABOTABL, San Diego, CA (US)

(21) Appl. No.: 19/037,454

(22) Filed: Jan. 27, 2025

Related U.S. Application Data
(60) Provisional application No. 63/551,256, filed on Feb. 8, 2024.

(51) Int. Cl. H04W 74/0833; H04L 5/14

(52) U.S. Cl. CPC H04W 74/0833; H04L 5/14

(57) ABSTRACT

Certain aspects of the present disclosure provide techniques for validity of random access channel (RACH) occasions (ROs) in subband full duplex (SBFD) slots. An example method, performed at a user equipment (UE), generally includes receiving a random access channel (RACH) configuration and a subband full duplex (SBFD) configuration, wherein the RACH configuration indicates one or more RACH occasions (ROs) and the SBFD configuration indicates at least one SBFD slot, processing a synchronization signal block (SSB) mapped to at least one first RO of the one or more ROs, determining the at least one first RO in the at least one SBFD slot is valid, based on the RACH configuration, the SBFD configuration, and the mapping, and transmitting a RACH preamble on the at least one first valid RO.

### CROSS-REFERENCE TO RELATED APPLICATION(S)

This application claims the benefit of and priority to U.S. Provisional Application No. 63/551,256, filed Feb. 8, 2024, which is assigned to the assignee hereof and hereby expressly incorporated by reference in its entirety as if fully set forth below and for all applicable purposes.

### FIELD OF THE DISCLOSURE

Aspects of the present disclosure relate to wireless communications, and more particularly, to techniques for validity of random access channel (RACH) occasions (ROs) in subband full duplex (SBFD) slots.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communications at a user equipment (UE). The method includes receiving a random access channel (RACH) configuration and a subband full duplex (SBFD) configuration, wherein the RACH configuration indicates one or more RACH occasions (ROs) and the SBFD configuration indicates at least one SBFD slot; processing a synchronization signal block (SSB) mapped to at least one first RO of the one or more ROs; determining the at least one first RO in the at least one SBFD slot is valid, based on the RACH configuration, the SBFD configuration, and the mapping; and transmitting a RACH preamble on the at least one first valid RO.

Another aspect provides a method of wireless communications at a network entity. The method includes transmitting a random access channel (RACH) configuration and a subband full duplex (SBFD) configuration, wherein the RACH configuration indicates one or more RACH occasions (ROs) and the SBFD configuration indicates at least one SBFD slot; transmitting a synchronization signal block (SSB) mapped to at least one first RO of the one or more ROs; determining the at least one first RO in the at least one SBFD slot is valid, based on the RACH configuration, the SBFD configuration, and the mapping; and monitoring for a RACH preamble, from a user equipment (UE), on the at least one first valid RO.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIGS. 5A, 5B, and 5C depict various examples of full duplex (FD) time/frequency resource configurations.

FIGS. 6A, 6B, and 6C depict various examples of full duplex configurations.

FIGS. 7A and 7B depict an example of inter-UE cross link interference (CLI).

FIG. 8 depicts an example of an FD base station performing simultaneous transmission and reception.

FIGS. 9A and 9B depict example uplink and downlink subbands for subband FD (SBFD) operations.

FIG. 10 depicts a call flow diagram illustrating an example four-step RACH procedure, in accordance with certain aspects of the present disclosure.

FIG. 11 depicts an example association of SSBs to RACH occasions (ROs).

FIG. 12 depicts example valid and invalid ROs in a PRACH slot.

FIG. 13 depicts an example call flow diagram, in accordance with certain aspects of the present disclosure.

FIG. 14A depicts example ROs in an SBFD slot that includes downlink symbols, in accordance with certain aspects of the present disclosure.

FIG. 14B depicts example ROs in an SBFD slot that includes flexible symbols, in accordance with certain aspects of the present disclosure.

FIGS. 15A and 15B depict example ROs in SBFD slots that include downlink symbols, in accordance with certain aspects of the present disclosure.

FIGS. 16A and 16B depict example ROs in SBFD slots that include downlink symbols, in accordance with certain aspects of the present disclosure.

FIG. 17 depicts a method for wireless communications.

FIG. 18 depicts a method for wireless communications.

FIG. 19 depicts aspects of an example communications device.

### DETAILED DESCRIPTION

Aspects of the present disclosure provide apparatuses, methods, processing systems, and computer-readable mediums for validity of random access channel (RACH) occasions (ROs) in subband full duplex (SBFD) slots.

Half duplex (HD) communication generally refers to a mode of communication where a device only transmits or receives over a single communication channel, but does not simultaneously transmit and receive. In a system utilizing a time division duplex (TDD) carrier, different transmission time intervals (e.g., symbols or slots) may be configured as uplink, downlink, or flexible (which could be dynamically indicated as uplink or downlink via a slot format indicator (SFI)).

Full duplex (FD) communication generally refers to a mode of communication where signals can be transmitted and received simultaneously over a single communication channel. In an FD mode, simultaneous transmission between wireless nodes, such as a user equipment (UE) and a base station (BS), may occur. Sub-band full duplex (SBFD) generally refers to a mode where a time division duplex (TDD) carrier is split into uplink and downlink sub-bands to enable simultaneous transmission and reception (on different subbands) in a same slot that consists of multiple symbols.

If a user equipment (UE) is operating in HD mode and a network entity, such as a gNodeB (gNB), is operating in an FD mode, such as SBFD or in-band FD (IBFD), interference may occur at the UE and gNB from a number of sources. For example, this interference may include inter-cell interference (ICI) from other gNBs, intra-cell cross-link interference (CLI) from UEs in the same cell, and inter-cell CLI from UEs in adjacent cells. Self-interference may also occur for both FD UEs and FD gNBs. In the case of FD gNBs, for example, self-interference may refer to a downlink transmission interfering with reception of an uplink transmission. These sources of interference may cause significant issues, including decreased spectral efficiency, increased power consumption, and poor UE performance.

In SBFD communication, guard bands may be used to separate frequency resources allocated for downlink (DL) and uplink (UL) signaling. In SBFD, the downlink and uplink signals may be transmitted on different subbands within the same frequency band. The guard band is a portion of the spectrum that is not used for either downlink or uplink communication, but is instead reserved to separate the subbands used for downlink and uplink signaling, preventing interference between them and allowing for a more reliable and efficient use of the available spectrum.

A Physical Random Access Channel (PRACH) generally refers to a channel used by user equipment (UE) to initiate communication with a base station (e.g., a gNB) in a cellular network. For example, as part of a random access (RA) channel procedure, the UE may send a preamble on the PRACH, after detecting a synchronization signal block (SSB) transmitted by the gNB. After successfully decoding a PRACH preamble, the gNB may respond with a Random Access Response (RAR) containing a Temporary Cell Identifier (TCI) and a timing advance (TA) value. The UE uses the TCI and TA to synchronize with the gNB and to access the network.

In PRACH, a random access channel (RACH) occasion (RO) generally refers to a specific time and frequency resource that maps to an SSB. The UE transmits a preamble sequence, from a set of preamble sequences, to initiate a Random Access (RA) procedure. The gNB uses the timing and frequency information associated with the RO to detect and decode the preamble and responds with the RAR.

In conventional systems, uplink transmissions are not allowed (or expected) in slots configured as downlink slots. Thus, ROs are typically only considered valid in uplink slots. However, there may be some ambiguity regarding the validity (or invalidity) of ROs in SBFD slots. Aspects of the present disclosure provide techniques related to determining validity of ROs in SBFD slots. Utilization of the techniques disclosed herein may resolve this ambiguity, facilitating RACH procedures involving SBFD-aware UEs, and resulting in improved quality of service (QOS), spectral efficiency, and overall system capacity.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

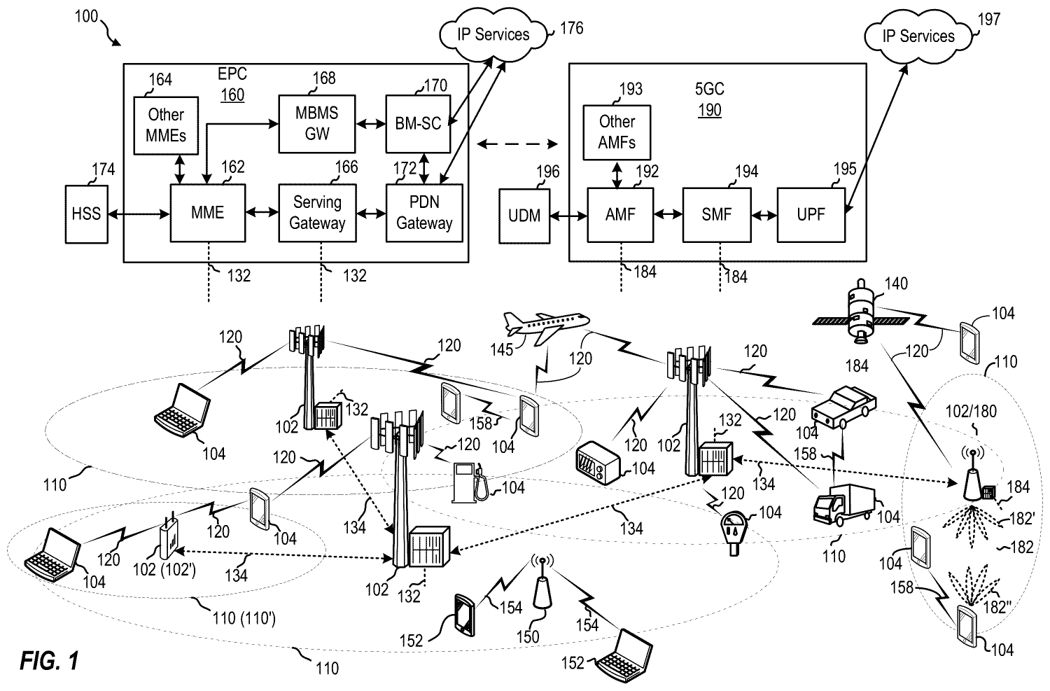

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

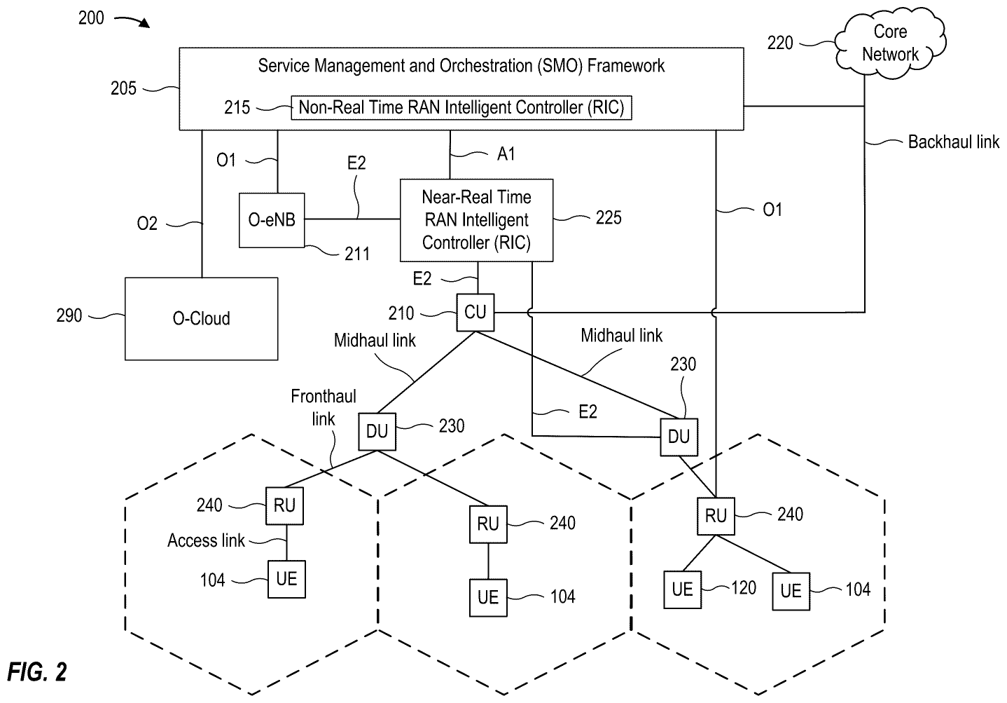

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUS), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

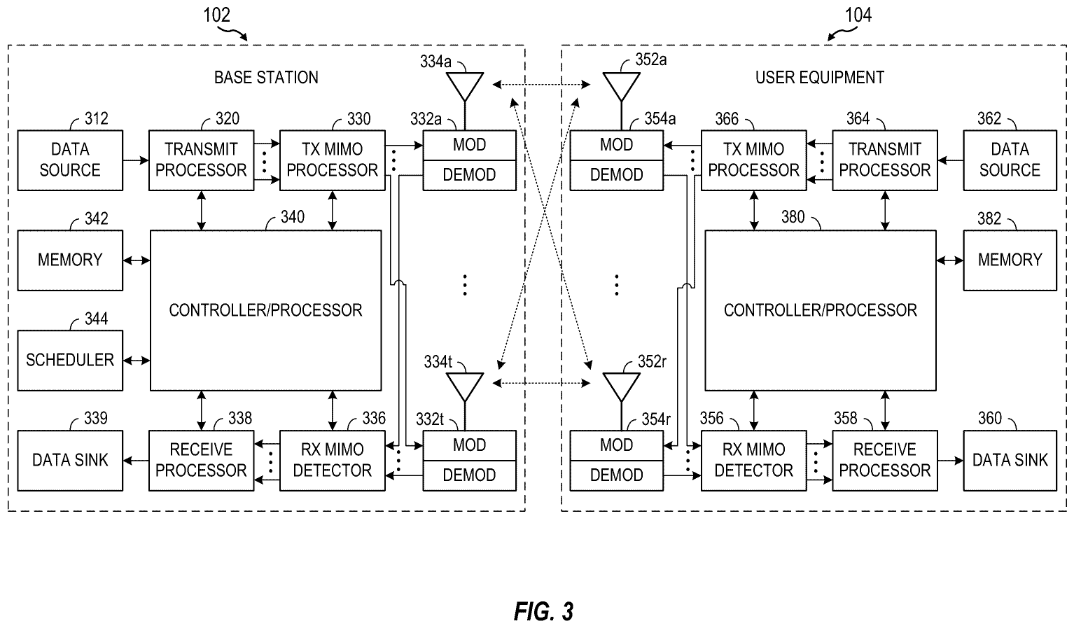

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

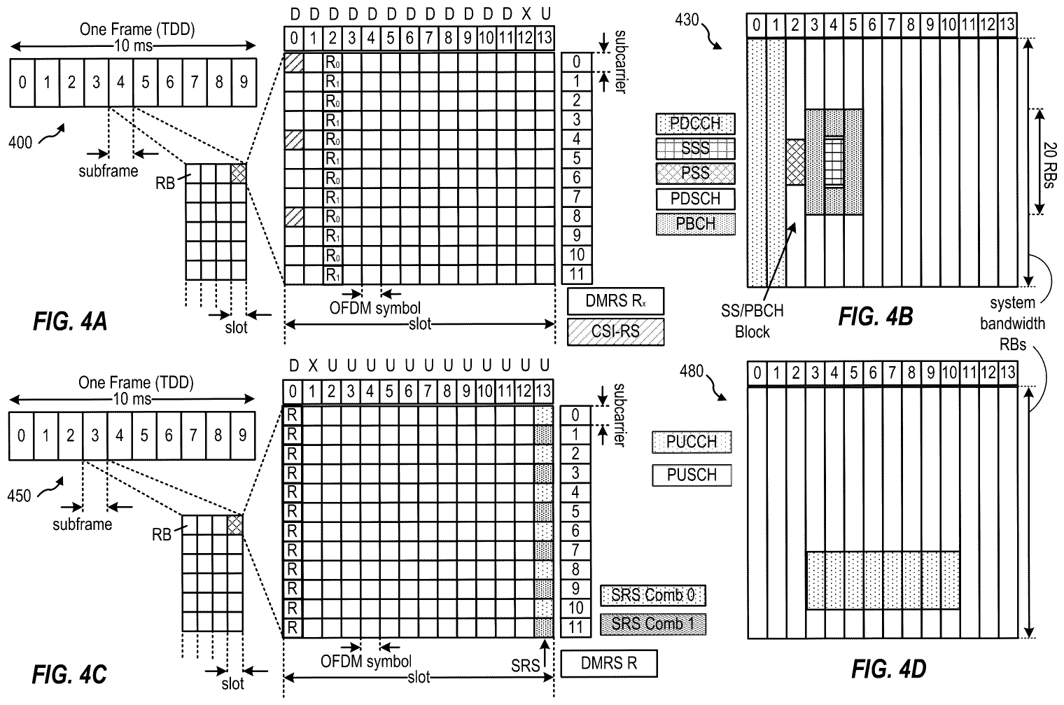

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of Full Duplex Communication

As noted above, a full-duplex (FD) device is capable of simultaneous bi-directional communications. In contrast, half-duplex (HD) devices are only capable of communications in one direction (transmit or receive) at one time.

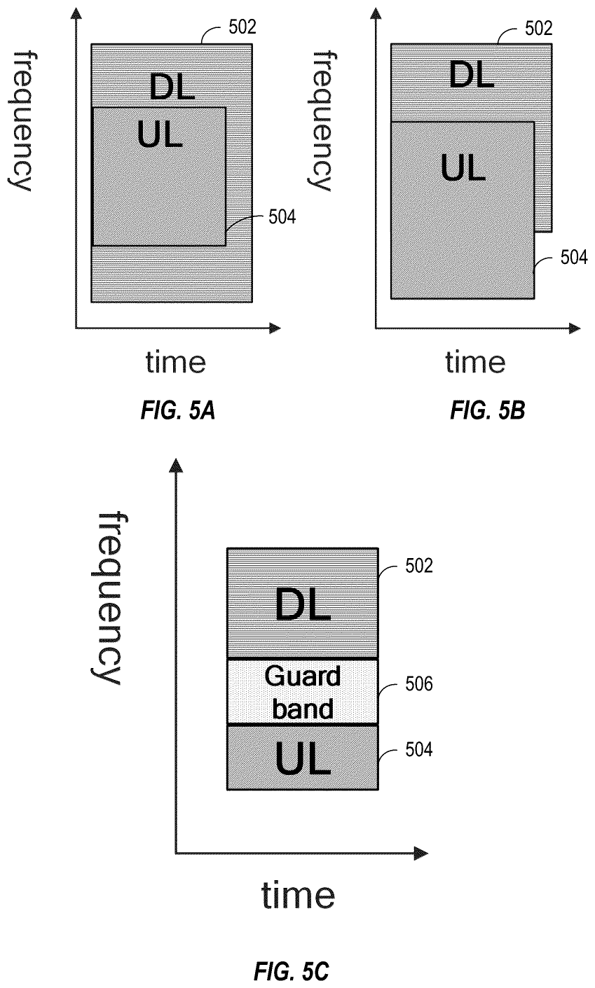

Examples of FD communication modes include in-band FD (IBFD) and sub-band FD. As illustrated in FIGS. 5A and 5B, with IBFD, a device may transmit and receive on the same time and frequency resources. In this case, the downlink (DL) 502 and uplink (UL) 504 share the same IBFD time and frequency resources which may fully overlap (FIG. 5A) or partially overlap (FIG. 5B).

As shown in FIG. 5C, with SBFD (also referred to a flexible duplexing), a device may transmit and receive at the same time, but using different frequency resources. In this case, the DL resource may be separated from the UL resource, in frequency domain, by a guard band 506.

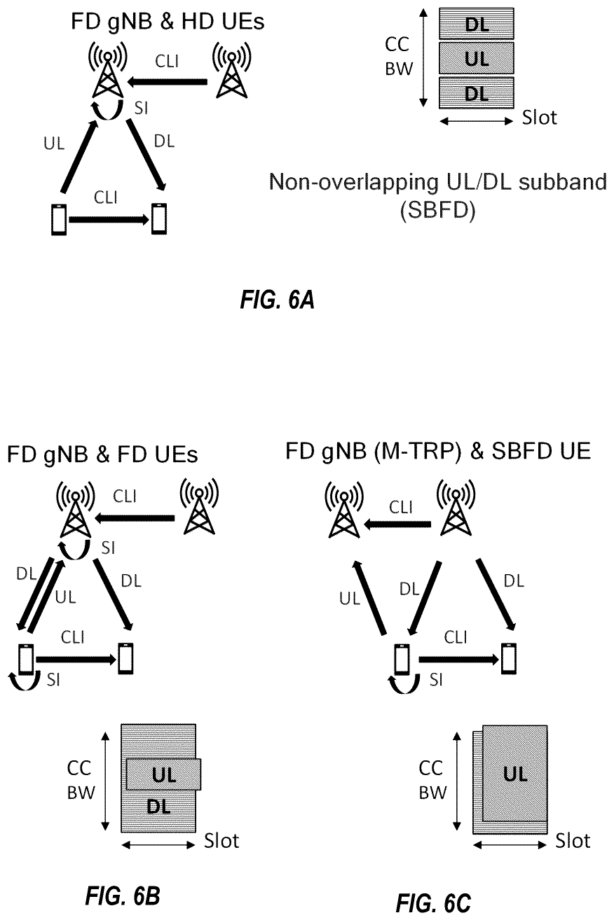

Interference to a UE and/or a network entity (e.g., a base station such as a gNB or node of a disaggregated base station) operating in FD mode may come in the form of CLI from neighboring nodes, as well as self-interference (SI). FIG. 6A, FIG. 6B, and FIG. 6C illustrate example interference scenarios for various FD communication use cases.

As illustrated in FIG. 6A, a first scenario is when FD is enabled for a gNB (e.g., with non-overlapping UL/DL subbands) but disabled for each connected UE (which in turn may be enabled for half-duplex (HD) communication), a gNB communicates using FD capabilities. In this case, CLI between UEs, SI from the FD gNB, and CLI between the gNB and neighboring gNBs interferes with FD communication.

As illustrated in FIG. 6B, a second scenario is when FD is enabled for both a gNB and a FD UE/customer premise equipment (CPE) connected to the gNB, the gNB communicates with the FD UE using FD capabilities. If the gNB is connected to a HD UE alongside the FD UE, the gNB communicates with the HD UE. In this case, CLI between UEs, SI from the gNB and the FD UE, and CLI between the FD gNB and neighboring gNBs interferes with FD communication.

As illustrated in FIG. 6C, a third scenario is when FD is enabled for two gNBs (e.g., in a multiple TRP scenario) and enabled at one UE/CPE connected to the two gNBs. In this case, the two gNBs may communicate with the FD UE using FD capabilities. If one of the two gNBs is connected to an HD UE alongside the FD UE, the one gNB communicates with both the HD UE and the FD UE. In this case, CLI between UEs, SI from the FD UE, and CLI between the two gNBs may interfere with FD communication.

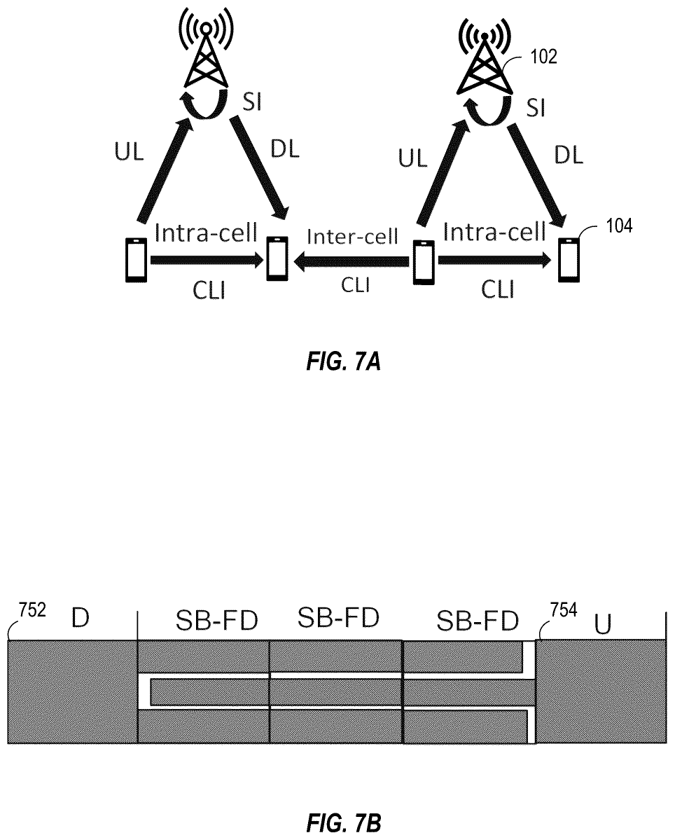

FIG. 7A also illustrates various forms of interference associated with FD communications. As illustrated, if a UE 104 is operating in HD mode and a gNB 102 is operating in FD (mode) SBFD/IBFD, sources of interference at the UE include inter-cell interference from other gNBs, intra-cell CLI from UEs in the same cell, and inter-cell CLI from UEs in adjacent cells. Additionally, there may be self-interference for FD UEs, particularly in SBFD slots that include both uplink subbands 754 and downlink subbands 752, as shown in FIG. 7B.

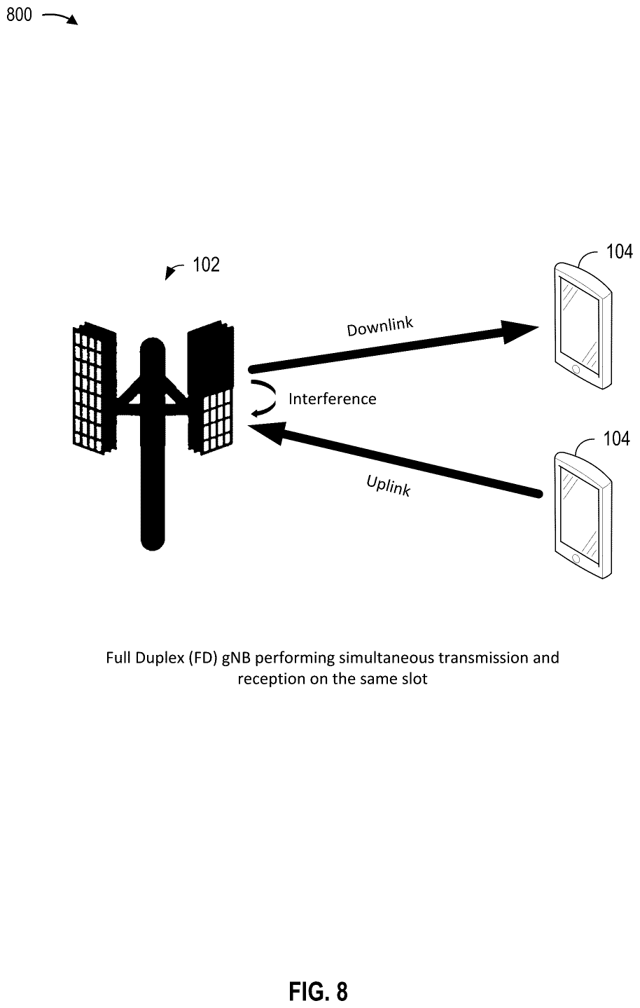

As noted above, an FD enabled device is capable of bi-directional network data transmissions at the same time. FIG. 8 illustrates an example of an FD enabled base station (an FD gNB) performing simultaneous transmission and reception on a same slot. As shown, the FD gNB may simultaneously perform a downlink transmission and receive an uplink transmission. As illustrated, the downlink transmission may be intended for a first UE, and the uplink transmission may be received from a second UE. In some cases, the downlink transmission and uplink transmission may both be associated with the same UE (e.g., if the UE is an FD UE). The simultaneous transmission and reception in a same slot may cause interference, as illustrated.

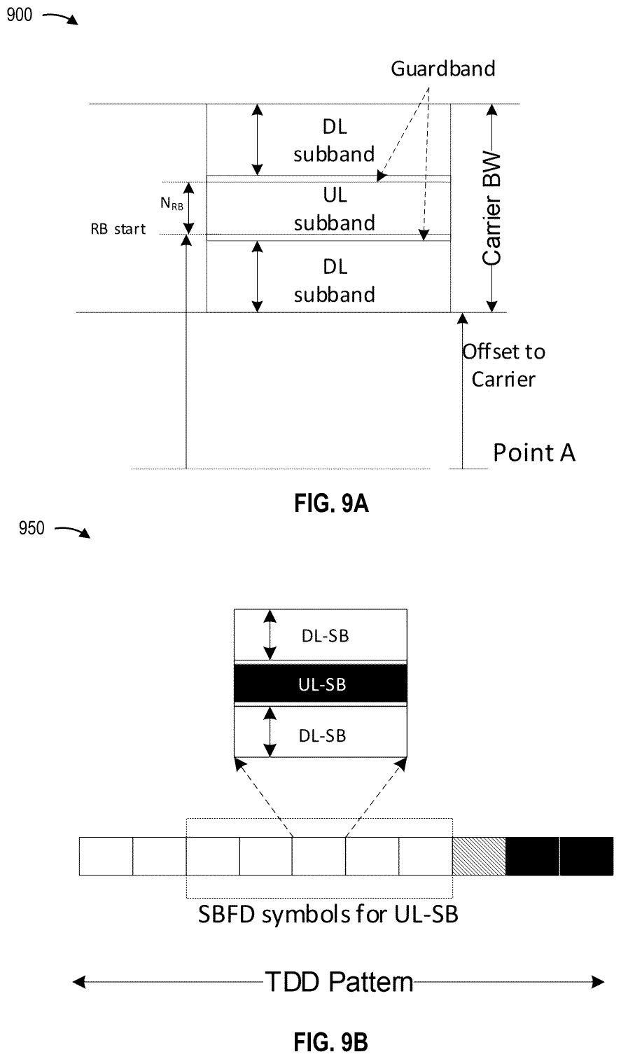

FIGS. 9A and 9B depict example uplink (UL) and downlink (DL) subbands for SBFD operations.

As illustrated in FIG. 9A, for example, UL and DL subbands may be allocated for SBFD operations within a carrier bandwidth (BW). As illustrated, for example, an UL subband allocation (e.g., and/or a DL subband allocation) may span NRB resource blocks (RBs). As noted above, and as illustrated, UL subbands and DL subbands may be separated by guard bands.

As illustrated in FIG. 9B, a time division duplexing (TDD) pattern may indicate a semi-static configuration of subband time locations for SBFD operation. In such cases, frequency locations of DL subband(s) may be explicitly configured with guardband(s), if any, implicitly derived as RBs which are not within UL subband or DL subband(s). In other cases, a number of RBs for guardband(s), if any, is explicitly configured. In such cases, DL subband(s) may be implicitly derived as RBs which are not within UL subband or guardband(s).

### Overview of Random Access Channel (RACH) Occasions (ROs)

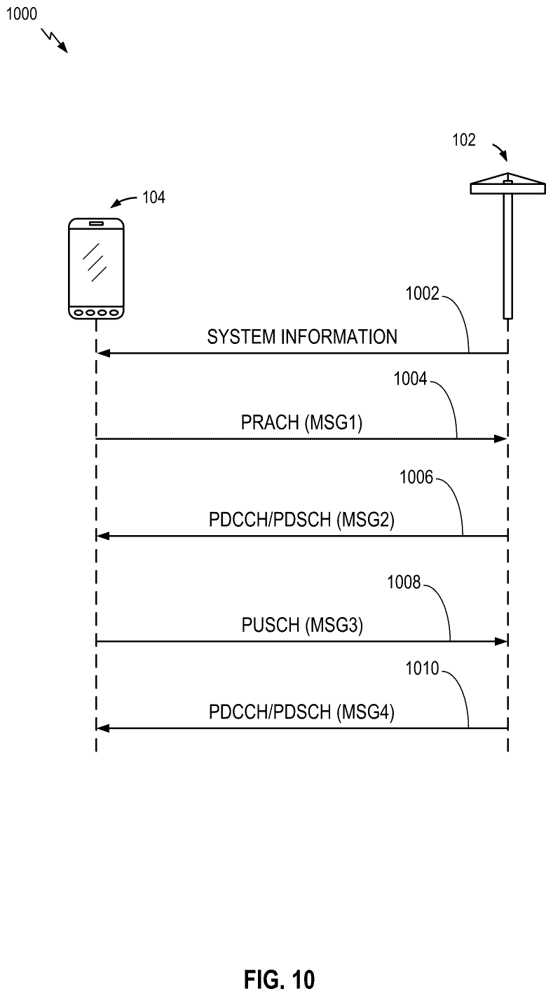

FIG. 10 is a call-flow diagram 1000 illustrating an example four-step RACH procedure, in accordance with certain aspects of the present disclosure. A first message (MSG1) may be sent from the UE 104 to BS 102 on the physical random access channel (PRACH). In this case, MSG1 may only include a RACH preamble 1004. BS 102 may respond with a random access response (RAR) message 1006 (MSG2) which may include the identifier (ID) of the RACH preamble, a timing advance (TA), an uplink grant, cell radio network temporary identifier (C-RNTI), and a back off indicator (BI). MSG2 may include a PDCCH communication including control information for (e.g., scheduling a reception of) a following communication on the PDSCH, as illustrated. In response to MSG2, MSG3 is transmitted from the UE 104 to BS 102 on the PUSCH 1008. MSG3 may include one or more of an RRC connection request, a tracking area update request, a system information request, a positioning fix or positioning signal request, or a scheduling request. The BS 102 then responds with MSG4 which may include a contention resolution message 1010. In some cases, the UE 104 may also receive system information 1002 (e.g., also referred to herein as a system information message) indicating various communication parameters that may be used by the UE 104 for communicating with the BS 102.

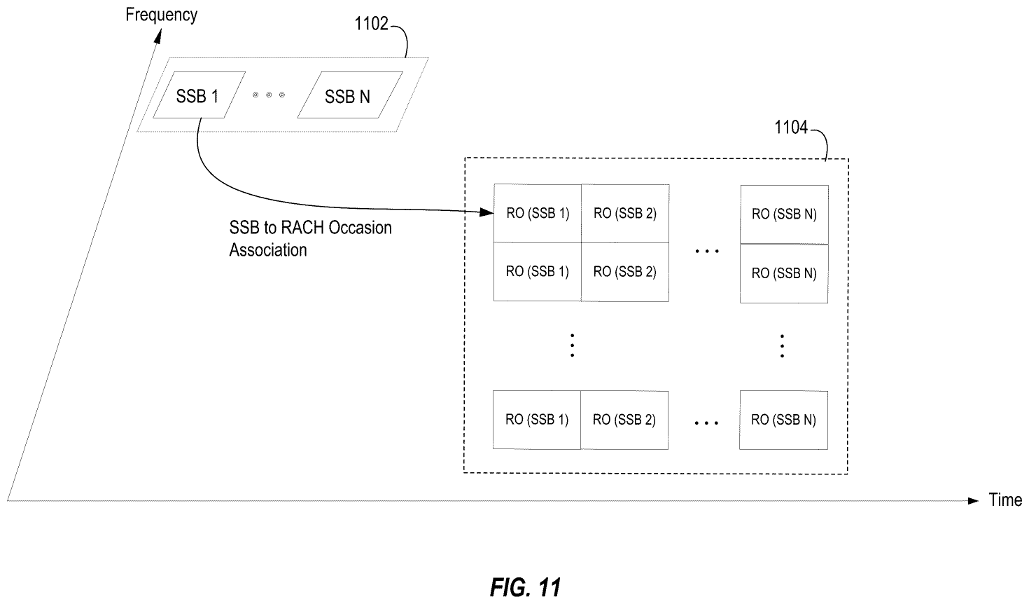

FIG. 11 depicts an example association (mapping) of SSBs 1102 to RACH occasions (ROs) 1104. This SSB to RO association is used for the gNB to know what beam the UE has acquired/is using (generally referred to as beam establishment). One SSB may be associated with one or more ROs or more than one SSB may be associated with one RO. Association is typically performed in the frequency domain first, then in the time domain within a RACH slot, then in the time domain across RACH slots (e.g., beginning with lower SSB indexes). An association period is typically defined as a minimum number of RACH configuration periods, such that all (configured) SSB beams are mapped into ROs.

In some cases, SSBs/beams detected in one BWP may be mapped to ROs in another BWP. In such cases, aspects of the present disclosure may adjust PRACH related timing to account for BWP switching (e.g., extending a timeline in which the UE is expected to transmit a PRACH to account for additional BWP switching delay).

### Overview of Validity of ROS

In some cases, (e.g., for unpaired spectrum), if a UE is not provided with tdd-UL-DL-ConfigurationCommon, a PRACH occasion in a PRACH slot may be considered valid if it does not precede a SS/PBCH block in the PRACH slot and starts at least N_{gap} symbols after a last SS/PBCH block reception symbol (e.g., where N_{gap} may be provided in a table of certain wireless communications standards) and, if channelAccessMode=“semiStatic” is provided, does not overlap with a set of consecutive symbols before the start of a next channel occupancy time where the UE does not transmit.

In some cases, if a UE is provided with tdd-UL-DL-ConfigurationCommon, a PRACH occasion in a PRACH slot may be considered valid if: it is within UL symbols, or it does not precede a SS/PBCH block in the PRACH slot and starts at least N_{gap} symbols after a last downlink symbol and at least N_{gap} symbols after a last SS/PBCH block symbol (e.g., where N_{gap} may be provided in a table of certain wireless communications standards), and if channelAccessMode=“semiStatic” is provided, does not overlap with a set of consecutive symbols before the start of a next channel occupancy time where there shall not be any transmissions.

The candidate SS/PBCH block index of the SS/PBCH block may correspond to the SS/PBCH block index provided by ssb-PositionsInBurst in SIB1 or in ServingCellConfigCommon.

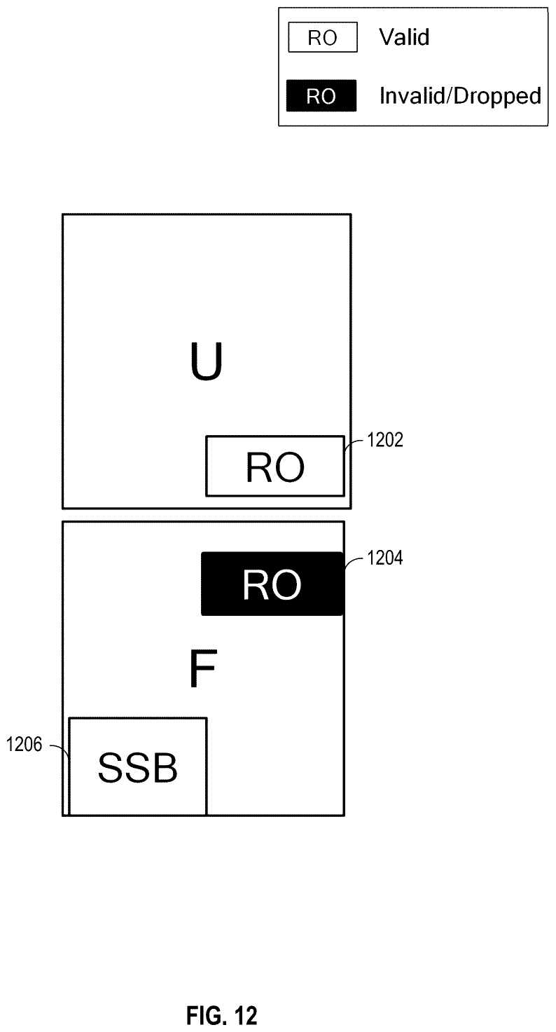

FIG. 12 depicts example valid and invalid ROs in a PRACH slot. For example, as illustrated, an RO 1202 within an UL symbol may be considered valid by a UE (e.g., if the UE is provided tdd-UL-DL-ConfigurationCommon), whereas an RO 1204 within a flexible symbol may be considered invalid (e.g., if it does not precede a SS/PBCH block 1206 in the PRACH slot and starts at least N_{gap} symbols after a last SS/PBCH block reception symbol).

### Aspects Related to Validity of ROs in SBFD Slots

Certain wireless communications standards (e.g., 3GPP Release 19) may permit ROs in SBFD slots (for RRC-connected mode). However, as noted above, there may be some ambiguity regarding the validity (or invalidity) of ROs in SBFD slots.

SBFD operation may be configured in downlink (D/DL) symbols, uplink (U/UL) symbols and/or flexible (F/FL) symbols. ROs in SBFD slots may be considered valid or invalid (e.g., for conventional UEs) depending on a slot type (e.g., D or F). For example, ROs in D slots may only be considered valid to SBFD-aware UEs, and these ROs may be configured separately from common ROs.

Aspects of the present disclosure provide techniques that may help resolve ambiguity related to determining validity of ROs in SBFD slots. These techniques may, in effect, align ROs in common slots between conventional and SBFD-aware UEs. For example, if an RO is in an SBFD slot with FL symbols, then the RO may be considered valid for both legacy and SBFD-aware UEs. On the other hand, ROs that are dedicated for SBFD may be considered valid only in SBFD in DL symbols.

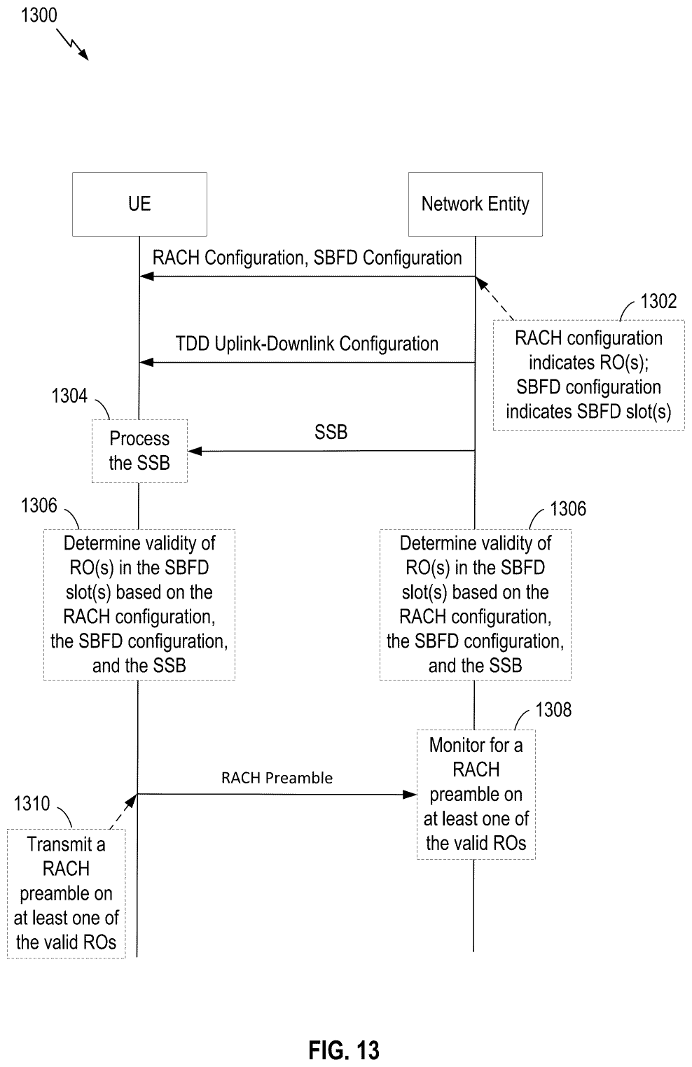

FIG. 13 depicts an example call flow diagram 1300, in accordance with certain aspects of the present disclosure. In some aspects, the UE shown in FIG. 13 may be an example of the UE 104 depicted and described with respect to FIGS. 1 and 3. In some aspects, the network entity shown in FIG. may be an example of the BS 102 (e.g., a gNB) depicted and described with respect to FIGS. 1 and 3 or a disaggregated base station depicted and described with respect to FIG. 2.

As illustrated at 1302, the network entity may transmit a RACH configuration that indicates one or more RACH occasions (ROs) and an SBFD configuration that indicates at least one SBFD slot. The network entity may also transmit a time division duplexing (TDD) uplink-downlink configuration that indicates slots (including the SBFD slot) as uplink, downlink, or flexible (denoted F or FL).

As illustrated at 1304, the UE may process an SSB transmitted by the network entity.

As illustrated at 1306, the UE and the network entity may each determine validity of one or more ROs in the at least one SBFD slot, based on the RACH configuration, the SBFD configuration, and the SSB/mapping.

As illustrated at 1308, the network entity may monitor for a RACH preamble on at least one of the valid ROs. As illustrated at 1310, the UE may transmit a RACH preamble on the at least one of the valid ROs, which the network may receive and process (e.g., participate in a RACH procedure).

In some cases, if a UE is not provided with TDD-UL-DL-ConfigurationCommon, all slots may be considered flexible (FL). If an SBFD pattern is indicated, then SBFD may be configured in FL symbols in all slots. In some cases, if a UE is provided with TDD-UL-DL-ConfigurationCommon, then SBFD may be configured in DL symbols and/or FL symbols.

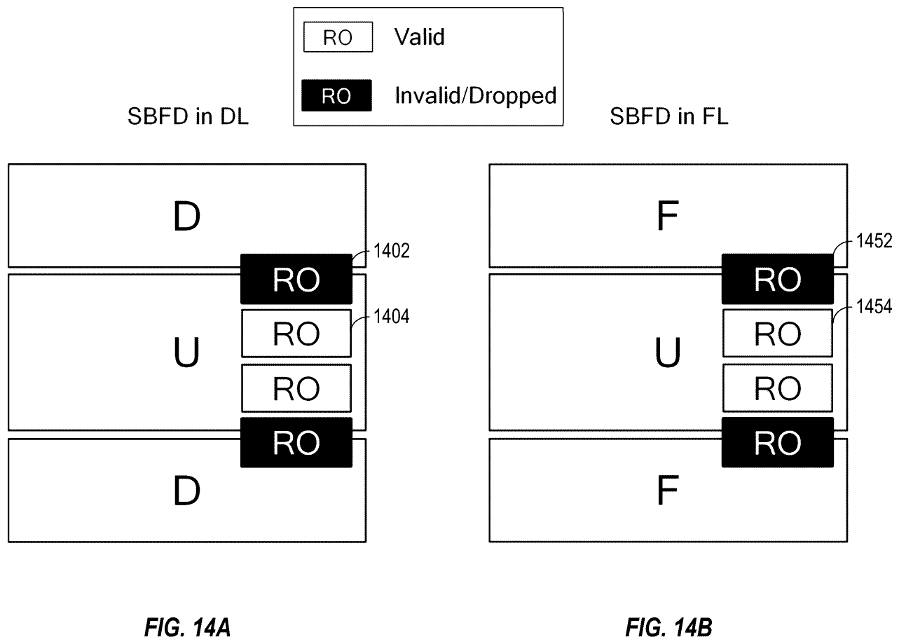

Aspects of the present disclosure provide techniques for determining validity of ROs that are partially or completely located outside of an UL subband in SBFD slots. In some aspects, such determinations may differentiate between SBFD in DL symbols and SBFD in FL symbols. In some aspects, if an RO is overlapping with a guard band and/or DL resources in SBFD slots, the RO may be considered invalid and/or may be dropped. These techniques may be understood with reference to FIGS. 14A/B.

FIG. 14A depicts example ROs in an SBFD slot that includes downlink symbols, in accordance with certain aspects of the present disclosure. As illustrated at 1402, for example, an RO that overlaps with a DL subband/resource in an SBFD slot (e.g., or overlaps with a guardband) may be considered invalid and/or dropped. In contrast, as illustrated at 1404, an RO that is (fully) contained within an uplink subband/resource in an SBFD slot may be considered valid.

FIG. 14B depicts example ROs in an SBFD slot that includes flexible symbols, in accordance with certain aspects of the present disclosure. As illustrated at 1452, for example, an RO that overlaps with a flexible subband/resource in an SBFD slot (e.g., or overlaps with a guardband) may be considered invalid and/or dropped. In contrast, as illustrated at 1454, an RO that is (fully) contained within an uplink subband/resource in an SBFD slot may be considered valid. In this context, a flexible subband refers to a subband that could be used as uplink or downlink, for example, depending on traffic demands. For example, a flexible subband may have RBs that can be dynamically used for UL transmission or DL transmission.

In some aspects, partial ROs may be allowed. For example, a sequence may be truncated to available resources. However, this technique may not be preferred, since it may impact the decoding performance at a network entity (e.g., a gNB).

For legacy UEs, DL slot ROs may be considered invalid. According to certain options, only ROs that are (fully) contained in an UL-BWP may be considered valid.

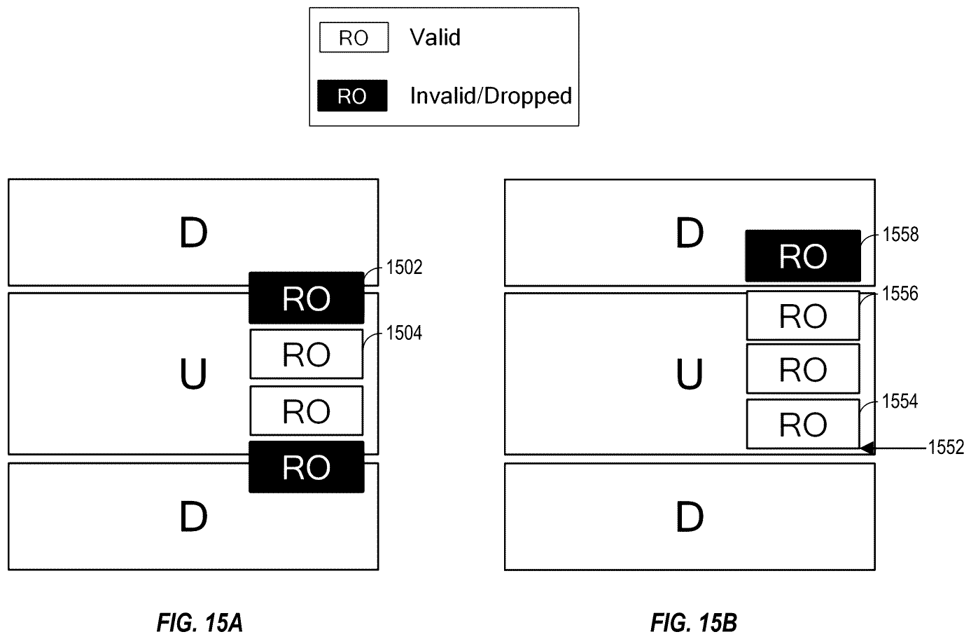

FIG. 15A and 15B depict example ROs in SBFD slots that include downlink symbols, in accordance with certain aspects of the present disclosure.

In some aspects, for an SBFD-aware UE, an RO in an SBFD slot may be considered valid according to multiple options. According to a first option (Option 1), an RO in an SBFD slot may be considered valid only if it is (fully) contained within an UL-SB. This first option may be characterized as a frequency consideration for determining the validity of ROs.

According to a second option (Option 2), all ROs may be considered valid, but a UE may drop (e.g., refrain from transmitting) PRACH on ROs that are outside of (e.g., not contained within) an UL-SB. In other words, the second option may not take into account any frequency considerations when determining validity of ROs. These dropped ROs may be mapped to SSBs, but may not be used for transmission (e.g., of a RACH preamble). This may lead to non-uniform assignment of ROs over SSBs.

Options 1 and 2 may be understood with reference to FIG. 15A. As illustrated at 1502, for example, ROs that are not contained within an UL-SB may be considered invalid (according to Option 1) or may be dropped (according to Option 2). In contrast, as illustrated at 1504, ROs contained within an UL-SB may be considered as valid, and may be used for (e.g., RACH preamble) transmission.

According to a third option (Option 3), validity of ROs may be subject to a gNB scheduling restriction. Such a scheduling restriction may, for example, dictate that a first RO must have a starting (or ending) frequency (e.g., RB) within an UL-SB in an SBFD slot. This may guarantee that at least some of ROs will be valid. In some aspects, the scheduling restriction may specify that in order for an RO to be considered valid, it must have a starting frequency (e.g., RB) within an UL-SB in an SBFD slot.

Option 3 may be understood with reference to FIG. 15B. As illustrated, a first RO 1554 has a starting frequency (RB) 1552 that is contained within an UL-SB of the SBFD slot. Thus, first RO 1554 may be considered valid, and may be used for (e.g., RACH preamble) transmission. As illustrated at 1556, an RO that has a starting frequency (e.g., RB) within an UL-SB in an SBFD slot may also be considered valid (e.g., even though the entirety of the RO is not contained within the UL-subband, and partially overlaps with a guardband). While not shown, a similar situation could occur where an RO is considered valid if it has an ending frequency that is within the UL-subband, but the entirety of the RO is not contained within the UL-subband (e.g., the starting frequency is outside the UL-subband). As illustrated at 1558, however, ROs that do not have a starting frequency (e.g., RB) contained within an UL-SB in an SBFD slot may be considered invalid or may be dropped.

According to a fourth option (Option 4), a UE may determine and apply a frequency (e.g., RB) offset such that an RO may be determined to be valid (e.g., contained within an UL-SB or has a starting frequency within an UL-SB). In some aspects, such an RB offset may be determined, by a UE, based on the frequency location of the UL-SB. In some aspects, the SBFD-aware UE may be explicitly configured with such an RB offset by the network (e.g., a gNB) via RRC signaling.

In some cases, an UL-SB may not be sufficient to accommodate all ROs, such as when many ROs are frequency domain multiplexed (FDMed). In some cases, in order to relax a number of ROs FDMed in any given symbol, ROs may be time domain multiplexed (TDMed) and FDMed. In some cases, how ROs are FDMed in an SBFD slot may be different than how ROs are FDMed in an UL slot (e.g., 6 ROs may be FDMed in an UL slot and only 2 may be FDMed in an SBFD slot).

In some aspects, a new element (e.g., FDM-ROs-SBFD-RACH-CFRA=2) may be included in an UL-SB configuration, which may overwrite FDM-ROs in a PRACH configuration information element (IE).

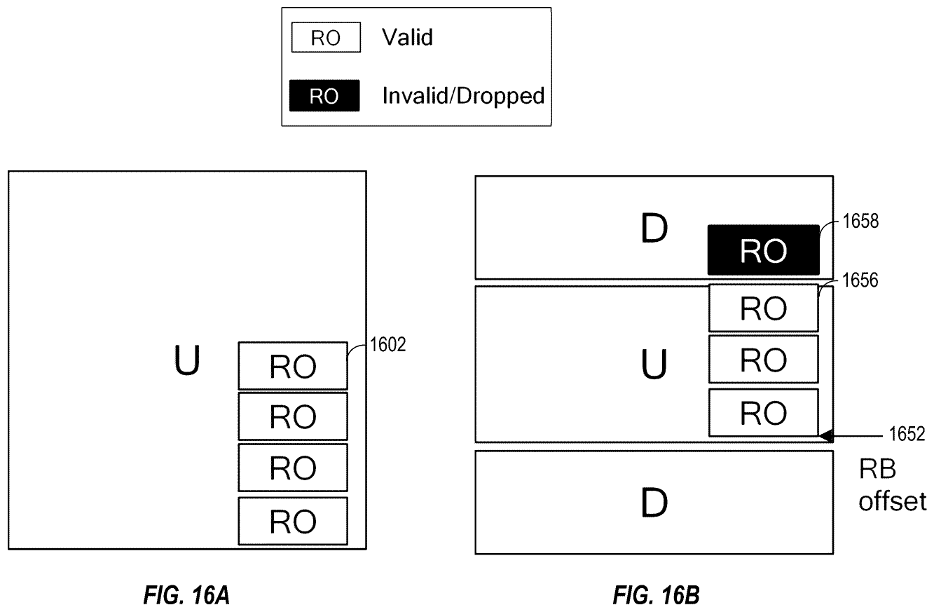

FIGS. 16A and 16B depict one example of how ROs may be FDMed differently in SBFD slots than in uplink slots. In the example of FIG. 16A, 4 ROs 1602 FDMed in an uplink slot are considered valid. In contrast, as illustrated in FIG. 16B, only 3 FDMed ROs 1656 in an SBFD slot may be considered valid. As illustrated, in some cases, the frequency locations of ROs in the SBFD slot may be determined by applying a frequency (e.g., RB) offset 1652 relative to a starting frequency position of the ROs 1602 in FIG. 16A. As illustrated, however, this may result in one of the ROs 1658 being outside of the UL SB, which may be considered invalid.

For a legacy UE, all ROs may be considered valid in a flexible (F/FL) slot. However, some SBFD-aware UEs may transmit in a DL-SB, whereas a gNB may (e.g., by configuration) either avoid or impose scheduling restrictions on the DL-SB.

In some aspects, for SBFD-aware UEs, a subset of ROs may be considered valid if the FL subband is assumed to be (e.g., treated as) a DL subband. In some aspects, a UE may not expect to be configured with an RO in FL symbols outside of an UL-SB. This may cause some UL resource fragmentation in an UL slot (e.g., UL and SBFD would share a common starting RB).

In some aspects, rules may dictate that no ROs are to be mapped in a flexible (FL) slot with an UL-SB. A flexible slot (or symbol) generally refers to a slot (or symbol) that can be used for either uplink or downlink (e.g., depending on need). In NR, slot format configuration can be done statically, semi-statically, or dynamically. For example, a slot configuration may be broadcast (e.g., via SIB1) and/or configured via RRC signaling. In general, static and semi-static slot configuration may be done via RRC signaling, while dynamic slot configuration is done via PDCCH/DCI. Typically, if a slot configuration is not provided (e.g., via RRC signaling), all slots/symbols may be considered as flexible by default. Slot configuration via RRC may involve two parts: first, providing a UE with a cell-specific slot format C\configuration (tdd-UL-DL-ConfigurationCommon) and, second, providing the UE with dedicated slot format configuration (tdd-UL-DL-ConfigurationDedicated).

In some cases, a scheduling restriction of the network may specify not to configure ROs in FL slots (or symbols) with SBFD. In other words, an SBFD-aware UE may not expect to be configured with ROs in any FL slot with SBFD.

In some aspects, the network may not impose any scheduling restrictions (e.g., which may have consequences in terms of cross-link interference (CLI)). In such cases, an SBFD-aware UE may not transmit outside of an UL-SB, whereas a legacy UE may transmit (e.g., but this may cause CLI issues and the transmission may not be received by the gNB).

In some aspects, all ROs may be considered valid if a FL subband is assumed to be (e.g., treated as) an UL subband.

As used herein, dropping an RO or a PRACH may refer to refraining from transmitting on the RO (e.g., refraining from transmitting a PRACH on the RO). As used herein, a valid RO may refer to an RO that a UE may use (e.g., is allowed or expected to use) to transmit a (P)RACH. In contrast, an invalid RO may refer to an RO that a UE may not use (e.g., may not be allowed or expected to use) to transmit a (P)RACH. Thus, by having rules that help determine when an RO is valid or invalid, a network entity (e.g., gNB) may only monitor valid ROs.

### Example Operations

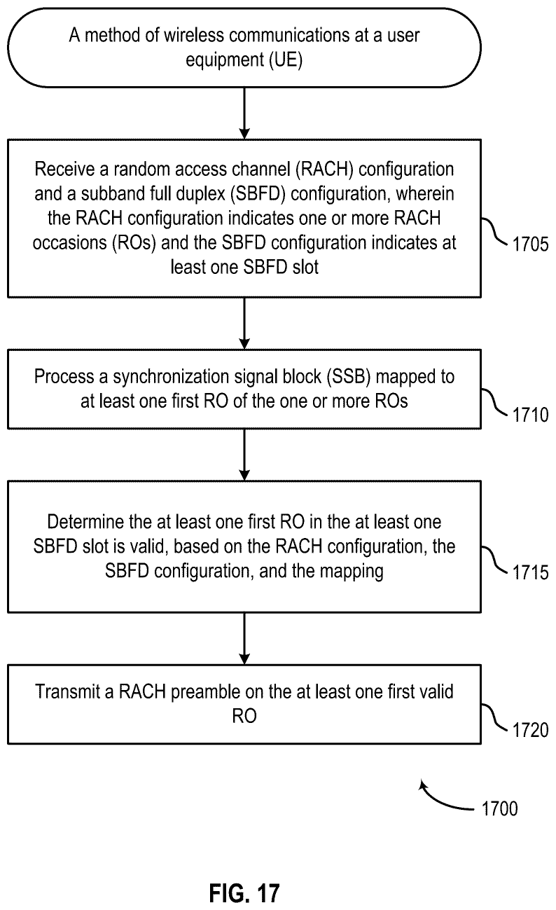

FIG. 17 shows an example of a method 1700 of wireless communications at a user equipment (UE), such as a UE 104 of FIGS. 1 and 3.

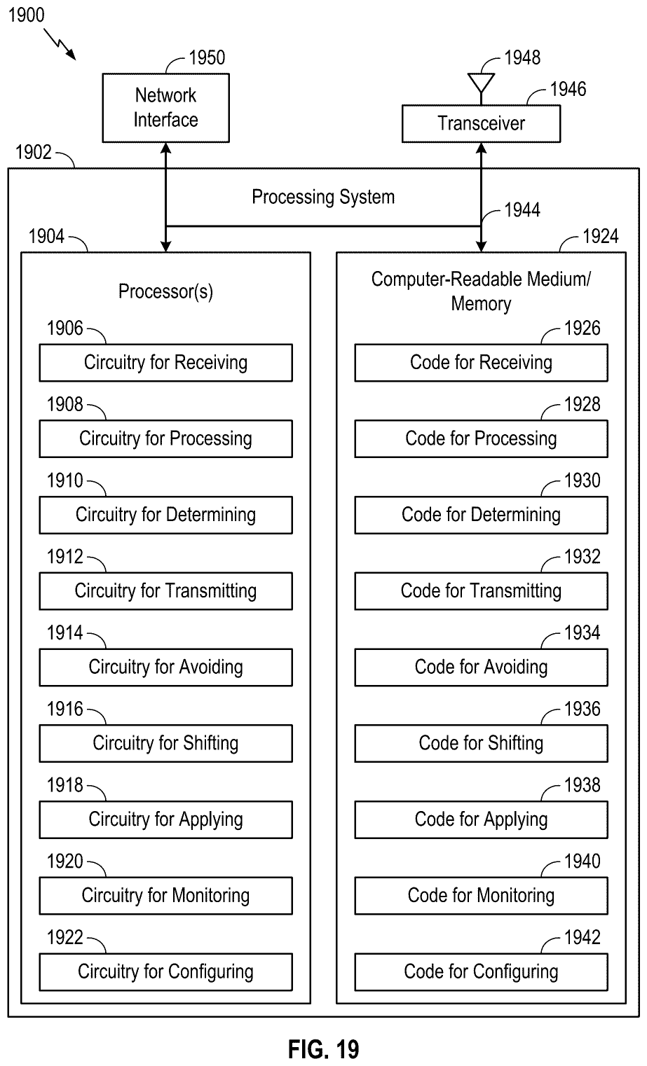

Method 1700 begins at step 1705 with receiving a random access channel (RACH) configuration and a subband full duplex (SBFD) configuration, wherein the RACH configuration indicates one or more RACH occasions (ROs) and the SBFD configuration indicates at least one SBFD slot. In some cases, the operations of this step refer to, or may be performed by, circuitry for receiving and/or code for receiving as described with reference to FIG. 19.

Method 1700 then proceeds to step 1710 with processing a synchronization signal block (SSB) mapped to at least one first RO of the one or more ROs. In some cases, the operations of this step refer to, or may be performed by, circuitry for processing and/or code for processing as described with reference to FIG. 19.

Method 1700 then proceeds to step 1715 with determining the at least one first RO in the at least one SBFD slot is valid, based on the RACH configuration, the SBFD configuration, and the mapping. In some cases, the operations of this step refer to, or may be performed by, circuitry for determining and/or code for determining as described with reference to FIG. 19.

Method 1700 then proceeds to step 1720 with transmitting a RACH preamble on the at least one first valid RO. In some cases, the operations of this step refer to, or may be performed by, circuitry for transmitting and/or code for transmitting as described with reference to FIG. 19.

In some aspects, the SBFD configuration indicates at least one SBFD pattern; and the determination is based on the SBFD pattern and an assumption that one or more slots are flexible.

In some aspects, the at least one SBFD slot is configured in a downlink slot.

In some aspects, an RO is determined to be valid only if the RO is contained within an uplink subband of the SBFD slot.

In some aspects, all ROs in the SBFD slot are determined to be valid; and the method further comprises avoiding selecting one or more of the ROs in the SBFD slot, for RACH preamble transmission, if they are outside of an uplink subband in the SBFD slot.

In some aspects, an RO is determined to be valid only if a starting frequency of the RO starts within an uplink subband of the SBFD slot.

In some aspects, the at least one SBFD slot is configured in a flexible slot with a flexible subband.

In some aspects, the flexible subband is assumed to be a downlink subband; and a subset of the ROs are determined to be valid.

In some aspects, the flexible subband is assumed to be an uplink subband; and all ROs in the SBFD slot are determined to be valid.

In one aspect, method 1700, or any aspect related to it, may be performed by an apparatus, such as communications device 1900 of FIG. 19, which includes various components operable, configured, or adapted to perform the method 1700. Communications device 1900 is described below in further detail.

Note that FIG. 17 is just one example of a method, and other methods including fewer, additional, or alternative steps are possible consistent with this disclosure.

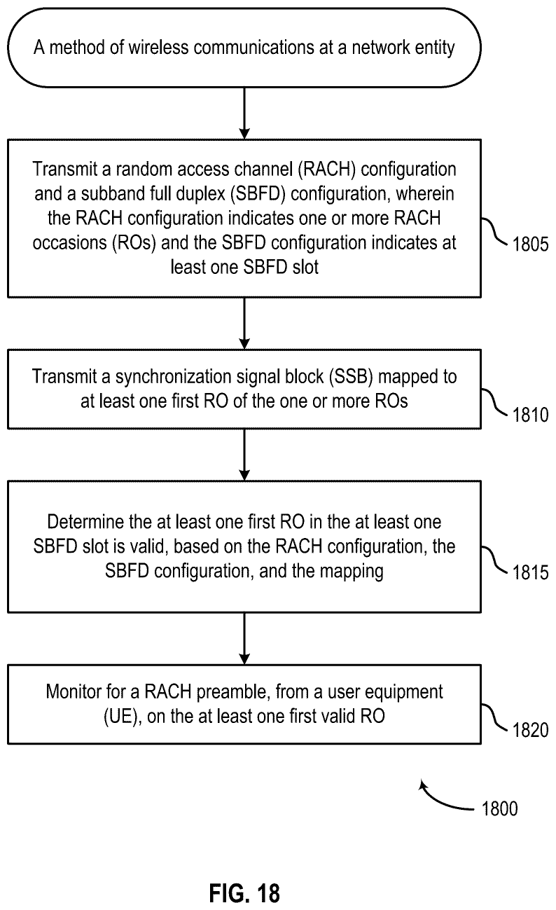

FIG. 18 shows an example of a method 1800 of wireless communications at a network entity, such as a BS 102 of FIGS. 1 and 3, or a disaggregated base station as discussed with respect to FIG. 2.

Method 1800 begins at step 1805 with transmitting a random access channel (RACH) configuration and a subband full duplex (SBFD) configuration, wherein the RACH configuration indicates one or more RACH occasions (ROs) and the SBFD configuration indicates at least one SBFD slot. In some cases, the operations of this step refer to, or may be performed by, circuitry for transmitting and/or code for transmitting as described with reference to FIG. 19.

Method 1800 then proceeds to step 1810 with transmitting a synchronization signal block (SSB) mapped to at least one first RO of the one or more ROs. In some cases, the operations of this step refer to, or may be performed by, circuitry for transmitting and/or code for transmitting as described with reference to FIG. 19.

Method 1800 then proceeds to step 1815 with determining the at least one first RO in the at least one SBFD slot is valid, based on the RACH configuration, the SBFD configuration, and the mapping. In some cases, the operations of this step refer to, or may be performed by, circuitry for determining and/or code for determining as described with reference to FIG. 19.

Method 1800 then proceeds to step 1820 with monitoring for a RACH preamble, from a user equipment (UE), on the at least one first valid RO. In some cases, the operations of this step refer to, or may be performed by, circuitry for monitoring and/or code for monitoring as described with reference to FIG. 19.

In some aspects, the SBFD configuration indicates at least one SBFD pattern; and the determination is based on the SBFD pattern and an assumption that one or more slots are flexible.

In some aspects, the at least one SBFD slot is configured in a downlink slot.

In some aspects, an RO is determined to be valid only if the RO is contained within an uplink subband of the SBFD slot.

In some aspects, all ROs in the SBFD slot are determined to be valid; and the method further comprises avoiding selecting one or more of the ROs in the SBFD slot, for RACH preamble monitoring, if they are outside of an uplink subband in the SBFD slot.

In some aspects, an RO is determined to be valid only if a starting frequency of the RO starts within an uplink subband of the SBFD slot.

In some aspects, the at least one SBFD slot is configured in a flexible slot with a flexible subband.

In some aspects, the flexible subband is assumed to be a downlink subband; and a subset of the ROs are determined to be valid.

In some aspects, the flexible subband is assumed to be an uplink subband; and all ROs in the SBFD slot are determined to be valid.

In one aspect, method 1800, or any aspect related to it, may be performed by an apparatus, such as communications device 1900 of FIG. 19, which includes various components operable, configured, or adapted to perform the method 1800. Communications device 1900 is described below in further detail.

Note that FIG. 18 is just one example of a method, and other methods including fewer, additional, or alternative steps are possible consistent with this disclosure.

### Example Communications Device(s)

FIG. 19 depicts aspects of an example communications device 1900. In some aspects, communications device 1900 is a user equipment, such as UE 104 described above with respect to FIGS. 1 and 3. In some aspects, communications device 1900 is a network entity, such as BS 102 of FIGS. 1 and 3, or a disaggregated base station as discussed with respect to FIG. 2.

The communications device 1900 includes a processing system 1902 coupled to the transceiver 1946 (e.g., a transmitter and/or a receiver). In some aspects (e.g., when communications device 1900 is a network entity), processing system 1902 may be coupled to a network interface 1950 that is configured to obtain and send signals for the communications device 1900 via communication link(s), such as a backhaul link, midhaul link, and/or fronthaul link as described herein, such as with respect to FIG. 2. The transceiver 1946 is configured to transmit and receive signals for the communications device 1900 via the antenna 1948, such as the various signals as described herein. The processing system 1902 may be configured to perform processing functions for the communications device 1900, including processing signals received and/or to be transmitted by the communications device 1900.

The processing system 1902 includes one or more processors 1904. In various aspects, the one or more processors 1904 may be representative of one or more of receive processor 358, transmit processor 364, TX MIMO processor 366, and/or controller/processor 380, as described with respect to FIG. 3. In various aspects, one or more processors 1904 may be representative of one or more of receive processor 338, transmit processor 320, TX MIMO processor 330, and/or controller/processor 340, as described with respect to FIG. 3. The one or more processors 1904 are coupled to a computer-readable medium/memory 1924 via a bus 1944. In certain aspects, the computer-readable medium/memory 1924 is configured to store instructions (e.g., computer-executable code) that when executed by the one or more processors 1904, cause the one or more processors 1904 to perform the method 1700 described with respect to FIG. 17, or any aspect related to it; and the method 1800 described with respect to FIG. 18, or any aspect related to it. Note that reference to a processor performing a function of communications device 1900 may include one or more processors 1904 performing that function of communications device 1900.

In the depicted example, computer-readable medium/memory 1924 stores code (e.g., executable instructions), such as code for receiving 1926, code for processing 1928, code for determining 1930, code for transmitting 1932, code for avoiding 1934, code for shifting 1936, code for applying 1938, code for monitoring 1940, and code for configuring 1942. Processing of the code for receiving 1926, code for processing 1928, code for determining 1930, code for transmitting 1932, code for avoiding 1934, code for shifting 1936, code for applying 1938, code for monitoring 1940, and code for configuring 1942 may cause the communications device 1900 to perform the method 1700 described with respect to FIG. 17, or any aspect related to it; and the method 1800 described with respect to FIG. 18, or any aspect related to it.

The one or more processors 1904 include circuitry configured to implement (e.g., execute) the code stored in the computer-readable medium/memory 1924, including circuitry for receiving 1906, circuitry for processing 1908, circuitry for determining 1910, circuitry for transmitting 1912, circuitry for avoiding 1914, circuitry for shifting 1916, circuitry for applying 1918, circuitry for monitoring 1920, and circuitry for configuring 1922. Processing with circuitry for receiving 1906, circuitry for processing 1908, circuitry for determining 1910, circuitry for transmitting 1912, circuitry for avoiding 1914, circuitry for shifting 1916, circuitry for applying 1918, circuitry for monitoring 1920, and circuitry for configuring 1922 may cause the communications device 1900 to perform the method 1700 described with respect to FIG. 17, or any aspect related to it; and the method 1800 described with respect to FIG. 18, or any aspect related to it.

Various components of the communications device 1900 may provide means for performing the method 1700 described with respect to FIG. 17, or any aspect related to it; and the method 1800 described with respect to FIG. 18, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1946 and the antenna 1948 of the communications device 1900 in FIG. 19. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1946 and the antenna 1948 of the communications device 1900 in FIG. 19.

### EXAMPLE CLAUSES

Implementation examples are described in the following numbered clauses:

Clause 1: A method of wireless communications at a user equipment (UE), comprising: receiving a random access channel (RACH) configuration and a subband full duplex (SBFD) configuration, wherein the RACH configuration indicates one or more RACH occasions (ROs) and the SBFD configuration indicates at least one SBFD slot; processing a synchronization signal block (SSB) mapped to at least one first RO of the one or more ROs; determining the at least one first RO in the at least one SBFD slot is valid, based on the RACH configuration, the SBFD configuration, and the mapping; and transmitting a RACH preamble on the at least one first valid RO.

Clause 2: The method of Clause 1, wherein: the SBFD configuration indicates at least one SBFD pattern; and the determination is based on the SBFD pattern and an assumption that one or more slots are flexible.

Clause 3: The method of any one of Clauses 1-2, further comprising: receiving a time division duplexing (TDD) uplink-downlink configuration that indicates one or more slots as downlink or flexible, wherein the at least one SBFD slot comprises one of the slots indicated as downlink or flexible.

Clause 4: The method of any one of Clauses 1-3, further comprising at least one of: determining at least one second RO is invalid if it overlaps with a guardband or downlink resources in an SBFD slot; and avoiding selecting one or more ROs, for RACH preamble transmission, if they overlap with a guardband or downlink resources in an SBFD slot.

Clause 5: The method of any one of Clauses 1-4, wherein the at least one SBFD slot is configured in a downlink slot. In some cases, if the at least one RO comprises multiple ROs that cannot be accommodated in an uplink subband of the at least one SBFD slot, the multiple ROs are time domain multiplexed and frequency domain multiplexed. In some cases, the multiple ROs are frequency domain multiplexed in the at least one SBFD slot in a different way than in an uplink slot.

Clause 6: The method of Clause 5, wherein an RO is determined to be valid only if the RO is contained within an uplink subband of the SBFD slot.

Clause 7: The method of Clause 5, wherein: all ROs in the SBFD slot are determined to be valid; and the method further comprises avoiding selecting one or more of the ROs in the SBFD slot, for RACH preamble transmission, if they are outside of an uplink subband in the SBFD slot. In some cases, ROs other than the subset of ROs of the multiple ROs are outside an uplink subband and are not used for RACH preamble transmission.

Clause 8: The method of Clause 5, wherein an RO is determined to be valid only if a starting (e.g., a lowest) and/or an ending (e.g., a highest) frequency of the RO starts (or ends) within an uplink subband of the SBFD slot.

Clause 9: The method of Clause 8, further comprising applying a frequency offset to shift a starting (e.g., a lowest) and/or an ending (e.g., a highest) frequency of an RO to start (or end) within an uplink subband of the SBFD slot.

Clause 10: The method of Clause 9, wherein the frequency offset is at least one of: determined by the UE based on an uplink subband of the SBFD slot, or configured via RRC signaling.

Clause 11: The method of any one of Clauses 1-10, wherein the at least one SBFD slot is configured in a flexible slot with flexible subband.

Clause 12: The method of Clause 11, wherein: the flexible subband is assumed to be a downlink subband; and a subset of the ROs are determined to be valid.

Clause 13: The method of Clause 11, wherein: the flexible subband is assumed to be an uplink subband; and all ROs in the SBFD slot are determined to be valid.

Clause 14: A method of wireless communications at a network entity, comprising: transmitting a random access channel (RACH) configuration and a subband full duplex (SBFD) configuration, wherein the RACH configuration indicates one or more RACH occasions (ROs) and the SBFD configuration indicates at least one SBFD slot; transmitting a synchronization signal block (SSB) mapped to at least one first RO of the one or more ROs; determining the at least one first RO in the at least one SBFD slot is valid, based on the RACH configuration, the SBFD configuration, and the mapping; and monitoring for a RACH preamble, from a user equipment (UE), on the at least one first valid RO.

Clause 15: The method of Clause 14, wherein: the SBFD configuration indicates at least one SBFD pattern; and the determination is based on the SBFD pattern and an assumption that one or more slots are flexible.

Clause 16: The method of any one of Clauses 14-15, further comprising: transmitting a time division duplexing (TDD) uplink-downlink configuration that indicates one or more slots as downlink or flexible, wherein the at least one SBFD slot comprises one of the slots indicated as downlink or flexible.

Clause 17: The method of any one of Clauses 14-16, further comprising at least one of: determining at least one second RO is invalid if it overlaps with a guardband or downlink resources in an SBFD slot; and avoiding selecting one or more ROs, for

RACH preamble monitoring, if they overlap with a guardband or downlink resources in an SBFD slot.

Clause 18: The method of any one of Clauses 14-17, wherein the at least one SBFD slot is configured in a downlink slot.

Clause 19: The method of Clause 18, wherein an RO is determined to be valid only if the RO is contained within an uplink subband of the SBFD slot.

Clause 20: The method of Clause 18, wherein: all ROs in the SBFD slot are determined to be valid; and the method further comprises avoiding selecting one or more of the ROs in the SBFD slot, for RACH preamble monitoring, if they are outside of an uplink subband in the SBFD slot.

Clause 21: The method of Clause 18, wherein an RO is determined to be valid only if a starting (e.g., a lowest) and/or an ending (e.g., a highest) frequency of the RO starts (or ends) within an uplink subband of the SBFD slot.

Clause 22: The method of Clause 21, further comprising applying a frequency offset to shift a starting (e.g., a lowest) and/or an ending (e.g., a highest) frequency of an RO to start (or end) within an uplink subband of the SBFD slot.

Clause 23: The method of Clause 22, wherein the frequency offset is based on an uplink subband of the at least one SBFD slot or configured via RRC signaling.

Clause 24: The method of any one of Clauses 14-23, wherein the at least one SBFD slot is configured in a flexible slot with a flexible subband.

Clause 25: The method of Clause 24, wherein: the flexible subband is assumed to be a downlink subband; and a subset of the ROs are determined to be valid.

Clause 26: The method of Clause 24, wherein: the flexible subband is assumed to be an uplink subband; and all ROs in the SBFD slot are determined to be valid.

Clause 27: An apparatus, comprising: at least one memory comprising executable instructions; and at least one processor configured to execute the executable instructions and cause the apparatus to perform a method in accordance with any one of Clauses 1-26.

Clause 28: An apparatus, comprising means for performing a method in accordance with any one of Clauses 1-26.

Clause 29: A non-transitory computer-readable medium comprising executable instructions that, when executed by at least one processor of an apparatus, cause the apparatus to perform a method in accordance with any one of Clauses 1-26.

Clause 30: A computer program product embodied on a computer-readable storage medium comprising code for performing a method in accordance with any one of Clauses 1-26.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, the term wireless node may refer to, for example, a network entity or a user equipment (UE). In this context, a network entity may be a base station (e.g., a gNB) or a module (e.g., a CU, DU, and/or RU) of a disaggregated base station.

While the present disclosure may describe certain operations as being performed by one type of wireless node, the same or similar operations may also be performed by another type of wireless node. For example, operations performed by a network entity may also (or instead) be performed by a UE. Similarly, operations performed by a UE may also (or instead) be performed by a network entity.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse direction relative to what is described (e.g., a UE could transmit a request to a network entity and the network entity transmits a response; OR a network entity could transmit the request to a UE and the UE transmits the response).

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

Means for receiving, means for processing, means for determining, means for transmitting, means for avoiding, and means for monitoring may comprise one or more processors, such as one or more of the processors described above with reference to FIG. 19.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication, comprising:
at least one memory comprising computer-executable instructions; and
one or more processors configured to execute the computer-executable instructions and cause the apparatus to:
receive a random access channel (RACH) configuration and a subband full duplex (SBFD) configuration, wherein the RACH configuration indicates one or more RACH occasions (ROs) and the SBFD configuration indicates at least one SBFD slot;
process a synchronization signal block (SSB) mapped to at least one first RO of the one or more ROs;
determine the at least one first RO in the at least one SBFD slot is valid, based on the RACH configuration, the SBFD configuration, and the mapping; and
transmit a RACH preamble on the at least one first valid RO.

2. The apparatus of claim 1, wherein:
the SBFD configuration indicates at least one SBFD pattern; and
the determination is based on the SBFD pattern and an assumption that a slot corresponding to the at least one SBFD slot is a flexible slot.

3. The apparatus of claim 1, wherein the one or more processors are further configured to cause the apparatus to:
receive a time division duplexing (TDD) configuration that indicates at least one slot as downlink or flexible, wherein the at least one SBFD slot comprises the at least one slot indicated as downlink or flexible.

4. The apparatus of claim 1, wherein the one or more processors are further configured to cause the apparatus to
determine at least one second RO is invalid if it overlaps with a guardband or downlink resources in an SBFD slot.

5. The apparatus of claim 1, wherein the at least one SBFD slot is configured in a downlink slot.

6. The apparatus of claim 5, wherein the at least one first RO is determined to be valid if the RO is contained within an uplink subband of the at least one SBFD slot.

7. The apparatus of claim 5, wherein:
multiple ROs in the at least one SBFD slot are determined to be valid; and
the one or more processors are further configured to cause the apparatus to select a subset of the multiple ROs for RACH preamble transmission, wherein the subset of ROs are within an uplink subband in the at least one SBFD slot.

8. The apparatus of claim 5, wherein the at least one first RO is determined to be valid if a lowest or highest frequency of the at least one first RO is within an uplink subband of the at least one SBFD slot.

9. The apparatus of claim 5, wherein the one or more processors are further configured to cause the apparatus to:
apply a frequency offset to the at least one first RO to shift a lowest or highest frequency of the at least one first RO to be within an uplink subband of the SBFD slot.

10. The apparatus of claim 9, wherein the frequency offset is based on an uplink subband of the at least one SBFD slot or configured via RRC signaling.

11. The apparatus of claim 1, wherein the at least one SBFD slot is configured in a flexible slot with a flexible subband.

12. The apparatus of claim 11, wherein:
the flexible subband is assumed to be a downlink subband; and
a subset of ROs in the at least one SBFD slot are determined to be valid.

13. The apparatus of claim 11, wherein:
the flexible subband is assumed to be an uplink subband; and
all ROs in the at least one SBFD slot are determined to be valid.

14. An apparatus for wireless communication, comprising:
at least one memory comprising computer-executable instructions; and
one or more processors configured to execute the computer-executable instructions and cause the apparatus to:
transmit a random access channel (RACH) configuration and a subband full duplex (SBFD) configuration, wherein the RACH configuration indicates one or more RACH occasions (ROs) and the SBFD configuration indicates at least one SBFD slot;
transmit a synchronization signal block (SSB) mapped to at least one first RO of the one or more ROs;
determine the at least one first RO in the at least one SBFD slot is valid, based on the RACH configuration, the SBFD configuration, and the mapping; and
monitor for a RACH preamble, from a user equipment (UE), on the at least one first valid RO.

15. The apparatus of claim 14, wherein:
the SBFD configuration indicates at least one SBFD pattern; and
the determination is based on the SBFD pattern and an assumption that a slot corresponding to the at least one SBFD slot is a flexible slot.

16. The apparatus of claim 14, wherein the one or more processors are further configured to cause the apparatus to:
transmit a time division duplexing (TDD) configuration that indicates at least one slot as downlink or flexible, wherein the at least one SBFD slot comprises the at least one slot indicated as downlink or flexible.

17. The apparatus of claim 14, wherein the one or more processors are further configured to cause the apparatus to
determine at least one second RO is invalid if it overlaps with a guardband or downlink resources in an SBFD slot.

18. The apparatus of claim 14, wherein the at least one SBFD slot is configured in a downlink slot.

19. The apparatus of claim 18, wherein the at least one first RO is determined to be valid if the RO is contained within an uplink subband of the at least one SBFD slot.

20. The apparatus of claim 18, wherein:
multiple ROs in the at least one SBFD slot are determined to be valid; and
the one or more processors are further configured to cause the apparatus to select a subset of the multiple ROs for RACH preamble monitoring, wherein the subset of ROs are within an uplink subband in the at least one SBFD slot.

21. The apparatus of claim 18, wherein the at least one first RO is determined to be valid if a lowest or highest frequency of the at least one first RO is within an uplink subband of the at least one SBFD slot.

22. The apparatus of claim 18, wherein the one or more processors are further configured to cause the apparatus to apply a frequency offset to shift a lowest or highest frequency of the at least one first RO to be within an uplink subband of the SBFD slot.

23. The apparatus of claim 22, the frequency offset is based on an uplink subband of the at least one SBFD slot or configured via RRC signaling.

24. The apparatus of claim 14, wherein the at least one SBFD slot is configured in a flexible slot with a flexible subband.

25. The apparatus of claim 24, wherein:
the flexible subband is assumed to be a downlink subband; and
a subset of ROs in the at least one SBFD slot are determined to be valid.

26. The apparatus of claim 24, wherein:
the flexible subband is assumed to be an uplink subband; and
all ROs in the at least one SBFD slot are determined to be valid.

27. A method of wireless communications at a user equipment (UE), comprising:
receiving a random access channel (RACH) configuration and a subband full duplex (SBFD) configuration, wherein the RACH configuration indicates one or more RACH occasions (ROs) and the SBFD configuration indicates at least one SBFD slot;
processing a synchronization signal block (SSB) mapped to at least one first RO of the one or more ROs;
determining the at least one first RO in the at least one SBFD slot is valid, based on the RACH configuration, the SBFD configuration, and the mapping; and
transmitting a RACH preamble on the at least one first valid RO.

28. A method of wireless communications at a network entity, comprising:
transmitting a random access channel (RACH) configuration and a subband full duplex (SBFD) configuration, wherein the RACH configuration indicates one or more RACH occasions (ROs) and the SBFD configuration indicates at least one SBFD slot;
transmitting a synchronization signal block (SSB) mapped to at least one first RO of the one or more ROs;
determining the at least one first RO in the at least one SBFD slot is valid, based on the RACH configuration, the SBFD configuration, and the mapping; and
monitoring for a RACH preamble, from a user equipment (UE), on the at least one first valid RO.
